(19) United States
(12) Patent Application Publication
(10) Pub. No.: US 2013/0164069 A1
(43) Pub. Date: Jun. 27, 2013

(54) PRINTER WITH A PROGRAMMABLE ARRAY

(71) Applicant: CTPG Operating, LLC, Ithaca, NY (US)

(72) Inventors: Robert Delaney, Ithaca, NY (US); Kyle Turner, Binghamton, NY (US); Barry Shaw, Groton, NY (US)

(73) Assignee: CTPG OPERATING, LLC, Ithaca, NY (US)

(21) Appl. No.: 13/725,083

(22) Filed: Dec. 21, 2012

Related U.S. Application Data
(60) Provisional application No. 61/578,273, filed on Dec. 21, 2011.

(51) Int. Cl. B41J 29/393

(52) U.S. Cl. CPC B41J 29/393
USPC 400/582

(57) ABSTRACT

A printer that images print media with an adhesive layer backing with an heat absorption substance. The printer contains control board with electronics and firmware to control the printer's various functions. It contains media storage to store the print media, and a platen mechanism to feed the print media. It contains a printhead to image the coloring layer of the media. The printer has a programmable array to activate the adhesive layer of the media once the imaging is complete and feed past the knife blades. If built with a cutter option, the printer contains a knife mechanism which cuts the media once the imaging and adhesive activation is complete.

### RELATED APPLICATIONS

The present application claims priority to U.S. Provisional Patent Application Ser. No. 61/578,273, filed Dec. 21, 2011, the entirety of which is hereby incorporated by reference.

### BACKGROUND OF THE INVENTION

1. Field of the Invention:

The present invention relates to printers and, more particularly, to printers that print media with adhesive backing.

Applications for printers have called for an adhesive layer to be added to the back of the print media. Once printed, the media can then be adhered to objects like a “post-it” note. McDonald's Corporation is using this “linerless” print media on drive-thru lanes in its restaurants. The adhesive layer on the linerless media presents many problems for the printer. As it is fed through the mechanism and printed, the adhesive is transferred to the platen, cutter, and other parts of the mechanism. Once this adhesive builds up on the mechanism, failures occur. Frequent service calls of the printer are required to clean the mechanism of this adhesive build up. Customer dissatisfaction results because of the poor reliability and the high cost of preventative maintenance. Printer manufacturers have designed mechanisms with special materials and coatings to minimize the transfer of the adhesive layer to the mechanism.

The use of special materials and coatings minimize the preventative maintenance required by the customer, but does not eliminate it. Also, the reliability failures that result from the buildup are minimized but not eliminated.

The printer using these special coated papers use higher energy to image the paper. The coating on the top of these papers reduces the transfer of adhesive to the printer, but the coating forces the printer to use more energy to image the paper. Also, the adhesive on the back of the paper requires more force and higher power to feed through the printer mechanism. The adhesive sticks to the top side and must be separated during the feed operations requiring more power from the printer.

The printer requires special features to operate the paper low function. Since the paper does not separate easily from the supply roll, it often rolls out of the paper bucket as it gets smaller in diameter and lighter in mass. The printer will need some extra parts to hold the roll using this special paper in place so that the paper low and paper out status can be accurately measured and reported to the host.

It would be advantageous to provide a low maintenance/maintenance free printer that can image print media with adhesive backing.

It would also be advantageous to provide a printer that can activate an adhesive layer on the print media after the media has been fed through the mechanism so that the adhesive layer will not transfer to parts of the printer.

It would further be advantageous to provide a programmable array on a printer that can activate an adhesive layer on the print media in various patterns. This would allow the user to control the location and size of the surface of the adhesive on the back of the print media.

It would further be advantageous to provide print media that can be mass produced in one configuration and then customized for the end user by the printer mechanism. The location and size of the adhesive is controlled by the programmable array. The paper roll manufacturer does not need to customize the location and size of the adhesive at the paper convertor. All rolls can be produced to the same specification and the cost for the media can be driven lower as a result.

### SUMMARY OF THE INVENTION

In accordance with the present invention, there is provided a printer that prints on media with an adhesive layer backing with a heat absorption substance. The printer contains control board with electronics and firmware to control the printer' s various functions. It contains media storage to hold the print media, and a platen mechanism to feed the media. It contains a printhead to image the print media. The printer has a programmable array to activate the adhesive layer of the media once the imaging is complete and fed past the knife blades. It contains a knife mechanism which cuts the media once the imaging and adhesive activation is complete.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a cross section view of a printer showing all the major elements of the printer; and

FIG. 2 is a cross section detail view of a print head, knife, platen, and programmable array.

For purposes of clarity and brevity, like elements and components will bear the same designations and numbering throughout the Figures.

### DESCRIPTION OF THE PREFERRED EMBODIMENT

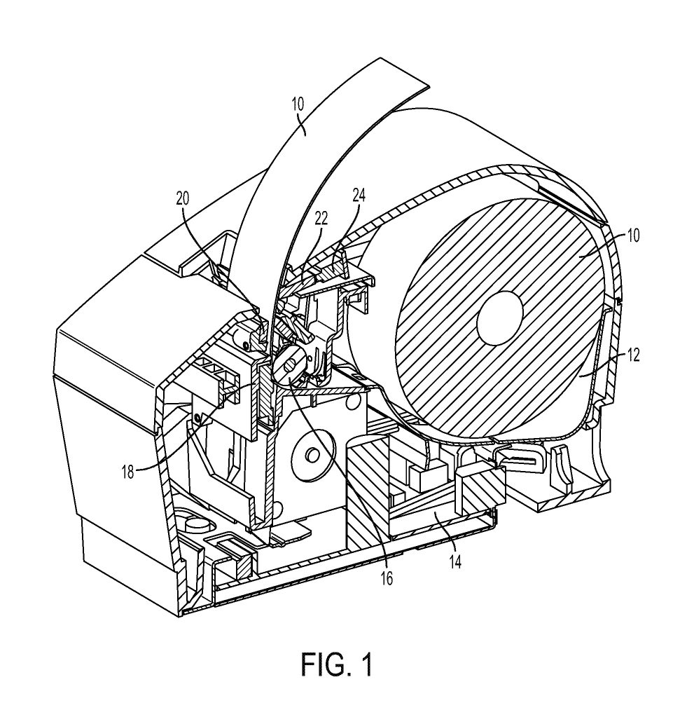

FIG. 1 is a cross section view of the printer showing all the major elements of the printer. The printer contains a print media supply 10 which contains paper with both an imaging layer for printing and an adhesive layer with a heat absorption substance. The print media supply 10 is held in a media storage 12. The media storage 12 provides the necessary guidance to the print media supply 10 so that it is properly tracked through the printer. A print media pathway guides the print media s it travels from print media supply 10 to an exit. The control electronics and firmware 14 contain both the hardware and software elements that control the functioning of the mechanical and electro-mechanical devices in the printer. The printhead 18 is a device that forms the print image on the imaging layer of the print media supply 10 as it is fed through the printer. The printhead 18 is controlled by the control electronics firmware. The platen 16 is the feedroll made from an elastomer material. It feeds the print media supply 10 through the printer and is controlled with the control electronics and firmware 14. The platen 16 is located adjacent to the printhead 18 so that the print media supply 10 can run between the printhead 18 and platen 16 for imaging. If the printer is built with a cutter option, the knife 20 is the mechanism that cuts the print media supply 10 once the imaging and adhesive activation is complete. It is controlled by the control electronics and firmware 14. The programmable array 24 is the programmable element that will activate the adhesive layer in the print media supply 10. It is controlled by the control electronics and firmware 14. The lens 22 is an element that can be used to focus the programmable array 24 onto the print media supply 10. It also provides a barrier between the print media supply 10 and programmable array 24 so that electrostatic discharge will not destroy the electronic hardware.

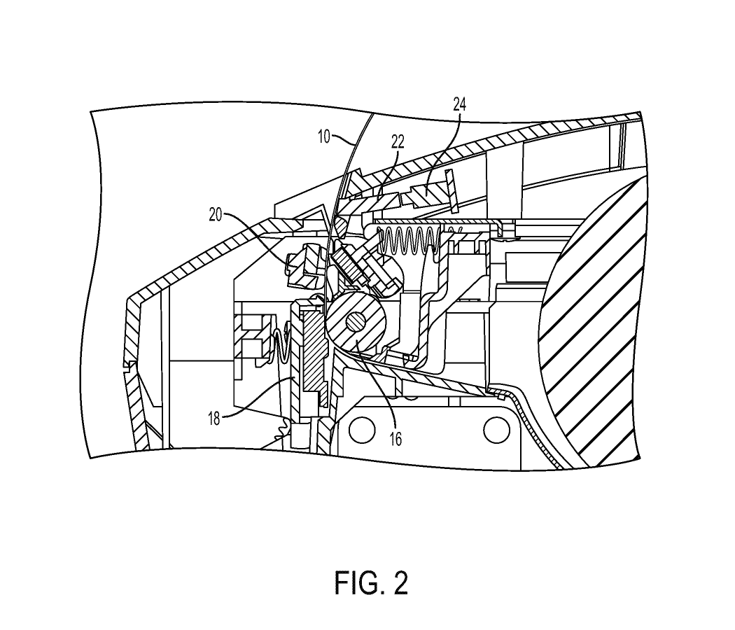

FIG. 2 is a cross section detail view showing the relative locations of the printhead 18, knife 20, platen 16, and programmable array 24. The printhead 18 and platen 16 are located below the knife 20 and programmable array 24. These elements do the imaging and feeding. The imaging occurs before the programmable array 24 activates the adhesive and before the knife 20 cuts the media. Since it is important that the printhead 18 and platen 16 stay free of adhesive buildup, the programmable array 24 activates the adhesive after the print media supply 10 is past these elements. Once the adhesive is activated by the programmable array 24, the knife 20 will cut the print media supply 10. Since the programmable array 24 is above the knife 20, no adhesive will be present on the part of the print media supply 10 which is cut. Therefore, no adhesive buildup will occur on the knife 20.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A printer for printing on print media containing an imaging surface on which printing occurs and a selectively actuable adhesive layer coating the opposite surface, said printer comprising:
a. a print media storage for storing the print media;
b. a print media pathway that guides the print media through the printer that begins at said print media storage and extends to a print media exit;
c. a platen positioned vertically adjacent said print media storage and adapted to feed the print media during a print operation;
d. a printhead positioned laterally adjacent said platen such that the print media is adapted to pass between said platen and said printhead during a print operation;
e. a programmable array positioned laterally adjacent said print media exit and vertically adjacent to said platen and on the opposite side of said platen as said print media storage, said programmable array adopted to transfer energy to activate the adhesive layer of the print media; and
f. printer controls in electrical communication with said platen, printhead, and programmable array.

2. The printer according to claim 1, further comprising a knife positioned between said print media exit and said printhead.

3. The printer according to claim 1, further comprising a lens positioned adjacent said programmable array and between said programmable array and the print media as it approaches said print media exit, said lens adapted to focus the energy transmitted from said programmable array to the adhesive layer.

4. A method for advancing print media that comprises a print surface and an opposite selectively actuable adhesive surface through a printer, comprising the steps of:
a. storing the print media in a print media storage within the printer;
b. actuating a platen to advance the print media along a print media pathway from said print media storage towards a print media exit;
c. actuating a printhead that causes printing to occur on the print surface of the print media;
d. actuating a programmable array to transfer energy to the adhesive surface of the print media after the print surface of the print media has been printed upon and immediately prior to the print media reaching the print media exit.
